(19) United States
(12) Patent Application Publication
(10) Pub. No.: US 2019/0339069 A1
(43) Pub. Date: Nov. 7, 2019

(54) OPTICAL MEASUREMENT APPARATUS

(71) Applicants: OLYMPUS CORPORATION, Tokyo (JP); NIPPON TELEGRAPH AND TELEPHONE CORPORATION, Tokyo (JP)

(72) Inventors: Daichi WATANABE, Tokyo (JP); Kanto MIYAZAKI, Tokyo (JP); Satomi KATAYOSE, Tokyo (JP); Kei WATANABE, Tokyo (JP); Yu KURATA, Tokyo (JP); Ryoichi KASAHARA, Tokyo (JP)

(73) Assignees: OLYMPUS CORPORATION, Tokyo (JP); NIPPON TELEGRAPH AND TELEPHONE CORPORATION, Tokyo (JP)

(21) Appl. No.: 16/517,736

(22) Filed: Jul. 22, 2019

Related U.S. Application Data
(63) Continuation of application No. PCT/JP2018/002212, filed on Jan. 25, 2018.

(30) Foreign Application Priority Data
Jan. 25, 2017 (JP) 2017-011686

(51) Int. Cl. G01B 11/24; G01B 11/25; G02B 7/02; G02F 1/01

(52) U.S. Cl. CPC G01B 11/2441; G01B 11/25; G02F 2203/50; G02F 1/011; G02B 7/02

(57) ABSTRACT

An optical measurement apparatus includes a light projector that projects a patterned light, and an imager that captures an image of a target onto which the patterned light has been projected. The light projector and the imager are fixed to each other via a mounting face that intersects both a projection axis direction of the light projector and an image acquisition axis direction of the imager.

### CROSS-REFERENCE TO RELATED APPLICATIONS

This application is based upon and claims the benefit of priority from the prior Japanese Patent Application No. 2017-011686, filed Jan. 25, 2017, the entire contents of which are incorporated herein by reference.

### BACKGROUND

### 1. Field of the Invention

The present intention relates to an optical measurement apparatus that projects a patterned light and acquires an image.

### 2. Description of the Related Art

As a method for measuring the three-dimensional shape of a measurement target, a so-called “fringe scanning method” is known. In this technique, a laser interference fringe is projected onto the measurement target, and an image of the projected interference fringe is captured and analyzed so as to calculate the surface peak and bottom information for the measurement target. With the fringe scanning method, the depth of the bottom and the height of the peak are calculated for each point based on the scanning amount of the interference fringe and the change in the light intensity for each point of the projected image. The scanning amount of the interference fringe is controlled by changing the phase difference between two or more light beams to be subjected to interference. For example, by changing the phase of one from among the light beams propagating through two branched optical waveguides using the electro-optical effect or the like, the scanning amount of the interference fringe to be projected can be controlled.

In a case in which the phase of the optical waveguide is changed using the electro-optical effect, such an arrangement requires a special material such as lithium niobate. In contrast, in a case in which the thermo-optic effect is employed, such a phase modulator can be configured with only typical silica materials formed on a silicon substrate. However, in a case in which an optical waveguide is formed on such a silicon substrate such that its temperature is changed, this arrangement has the potential to cause the occurrence of warpage of the substrate or the like due to the difference in the thermal expansion rate or the like between the substrate and the optical waveguide. In some cases, this leads to a change of the interference fringe projection position. In a case in which such a change of the interference fringe projection position occurs due to such causes other than the phase shifting of the optical waveguide, this leads to degradation of the measurement precision.

### SUMMARY

The present invention has been made in view of such a situation. Accordingly, it is an exemplary purpose of an embodiment of the present invention to provide an optical measurement apparatus that is capable of suppressing degradation of measurement precision that can occur due to thermal deformation.

An optical measurement apparatus according to an embodiment of the present invention comprises: a light projector unit structured to emit a patterned light; and an image acquisition unit structured to acquire an image of a target onto which the patterned light has been projected. The light projector unit and the image acquisition unit are fixed to each other via a mounting face that intersects a projection axis direction defined by the light projector unit and an image acquisition axis defined by the image acquisition unit.

It should be noted that any combination of the components described above or any manifestation of the present invention, may be mutually substituted between a method, apparatus, system, and so forth, which are also effective as an embodiment of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram showing a schematic configuration of an optical measurement apparatus according to a first example;

FIG. 2 is a top view showing a more detailed view of an end portion shown in FIG. 1;

FIG. 3 is a side view showing a schematic configuration of a light projector unit;

FIG. 4 is a schematic side view showing a change in the projection axis in a case in which warpage has occurred in an optical circuit unit according to a comparison example;

FIG. 5 is a schematic side view showing a change in the projection axis in a case in which warpage has occurred in an optical circuit unit according to an example;

FIG. 6 is a top view showing a schematic configuration of an optical measurement apparatus according to a second example;

FIG. 7 is a side view showing a schematic configuration of the optical measurement apparatus according to the second example;

FIG. 8 is a top view showing a schematic configuration of an optical measurement apparatus according to a third example;

FIG. 9 is a top view showing a schematic configuration of an optical measurement apparatus according to a modification;

FIG. 10 is a top view showing a schematic configuration of an optical measurement apparatus according to a modification;

FIG. 11 is a top view showing a schematic configuration of an optical measurement apparatus according to a modification; and

FIG. 12 is a top view showing a schematic configuration of an optical measurement apparatus according to a modification.

### DETAILED DESCRIPTION

The invention will now be described by reference to the preferred embodiments. This does not intend to limit the scope of the present invention but to exemplify the invention.

First, description will be made regarding a summary of several embodiments according to the present invention.

An optical measurement apparatus according to an embodiment comprises: a light projector unit structured to emit a patterned light; and an image acquisition unit structured to acquire an image of a target onto which the patterned light has been projected. The light projector unit and the image acquisition unit are fixed to each other via a mounting face that intersects a projection axis direction defined by the light projector unit and an image acquisition axis defined by the image acquisition unit.

With this embodiment, the light projector unit and the image acquisition unit are fixedly mounted with the mounting face that intersects both the projection axis direction and the image acquisition axis direction as a reference. Accordingly, this arrangement involves only a small change in the relative positions of the projector unit and the image acquisition unit even if the position of the mounting face changes due to thermal deformation that occurs due to the difference in the thermal expansion ratio. Furthermore, this arrangement involves only a small change in the direction along the mounting face as compared with the change in the direction that intersects the mounting face even if thermal warpage occurs in the mounting face due to heat generation. This allows the change in the relative positions to be suppressed in a direction in which the projection axis and the image acquisition axis deviate from each other. This arrangement is capable of suppressing the change in position in the image acquisition direction with respect to the position onto which the patterned light has been projected. Accordingly, this arrangement is capable of suppressing degradation of measurement precision.

Also, the light projector unit may comprise the mounting face. Also, the image acquisition unit may be fixedly mounted on the mounting face.

Also, the optical measurement apparatus may further comprise a housing structured to house the light projector unit and the image acquisition unit within an internal portion thereof. Also, the light projector unit may be fixed to the housing. Also, the image acquisition unit may be fixed to the housing via the light projector unit.

Also, the light projector unit may comprise: a substrate; and an optical circuit unit provided on the substrate, and comprising multiple waveguides each capable of supporting phase modulation. Also, the image acquisition unit may be fixed to the optical circuit unit.

Also, the light projector unit may further comprise: a projection lens structured to generate interference between multiple light beams emitted from the multiple waveguides so as to project the patterned light onto the target; and a lens holder unit structured to hold the projection lens. Also, the lens holder unit may be fixed to the optical circuit unit.

Also, the optical circuit unit may comprise a side face provided with outlets of the multiple waveguides. Also, the image acquisition unit may be fixedly mounted on the side face.

Also, the optical circuit unit may comprise a side face provided with outlets of the multiple waveguides. Also, the image acquisition unit and the lens holder unit may be fixedly mounted on the side face.

Also, the optical circuit unit may comprise a first side face provided with outlets of the multiple waveguides, and a second side face provided at a position with an offset with respect to the first side face in the projection axis direction. Also, the image acquisition unit may be fixedly mounted on the first side face.

Also, the optical circuit unit may comprise a first side face provided with outlets of the multiple waveguides, and a second side face provided at a position with an offset with respect to the first side face in the projection axis direction. Also, the lens holder unit may be fixedly mounted on the first side face. Also, the image acquisition unit may be fixedly mounted on the second side face.

Also, the optical measurement apparatus may further comprise a fixing member having the mounting face. Also, both the light projector unit and the image acquisition unit may be mounted on the mounting face.

Also, the fixing member may be structured to have light transmissivity. Also, the light projector unit may project the patterned light onto the target through the fixing member. Also, the image acquisition unit may acquire an image of the target through the fixing member.

Also, the optical measurement apparatus may further comprise a housing structured to house the light projector unit and the image acquisition unit in an internal portion thereof. Also, the fixing member may be fixed to the housing. Also, the light projector unit and the image acquisition unit may be fixed to the housing via the fixing member.

Also, the light projector unit may comprise: a substrate; and an optical circuit unit provided on the substrate, and comprising multiple waveguides each capable of supporting phase modulation. Also, the optical circuit unit may be fixedly mounted on the mounting face of the fixing member.

Also, the light projector unit may comprise: an optical circuit unit including a substrate and multiple waveguides provided on the substrate, each of the multiple waveguides being capable of supporting phase modulation; a projection lens structured to generate interference between multiple light beams emitted from the multiple waveguides, so as to project the patterned light onto the target; and a lens holder unit structured to hold the projection lens. Also, the optical circuit unit may be fixedly mounted on the mounting face of the fixing member via the lens holder unit.

Also, the optical circuit unit may be structured to have a side face that intersects the projection axis direction. Also, the lens holder unit may be fixedly mounted on the side face.

Also, the optical circuit unit may be structured such that the side face thereof is provided with outlets of the multiple waveguides.

Detailed description will be made below with reference to the drawings regarding an embodiment for realizing the present invention. It should be noted that, in description with reference to the drawings, the same components are denoted by the same reference symbols, and redundant description thereof will be omitted as appropriate. Each arrangement will be described for exemplary purposes only, and by no means restricts the scope of the present invention.

### First Example

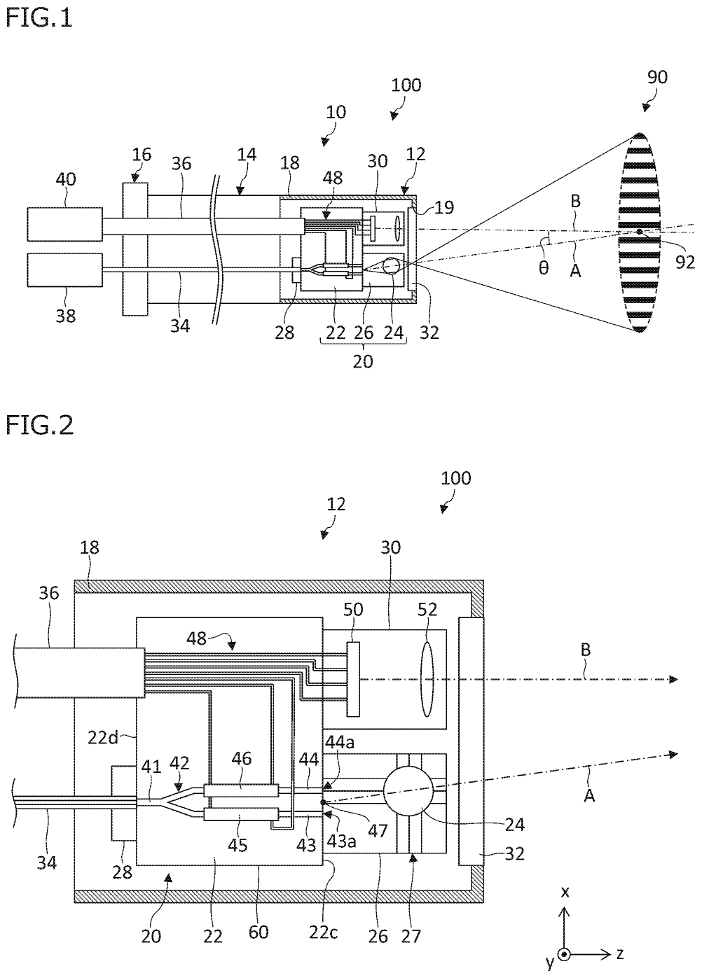

FIG. 1 is a schematic diagram showing a configuration of an optical measurement apparatus 100 according to a first example. The optical measurement apparatus 100 includes a light projector unit 20, an image acquisition unit 30, a light source 38, and a control unit 40. The optical measurement unit 100 is built into an endoscope 10 including an end portion 12, an insertion portion 14, and a coupling portion 16. The optical measurement unit 100 is used to measure a three-dimensional shape of a target portion within a lumen in a state in which it is set such that the end portion 12 faces the target. The optical measurement apparatus 100 is used to measure a target using a so-called “fringe scanning method” which is a three-dimensional measurement method.

The end portion 12 is a portion configured to house the light projector unit 20 and the image acquisition unit 30, and to have an outer face configured as a housing 18 formed of a hard material such as metal or the like. The end of the housing 18 is provided with a cover glass 32. The insertion portion 14 is configured as a flexible member. By bending a portion in the vicinity of the end portion 12, this arrangement allows the direction of the end portion 12 to be adjusted. Accordingly, the endoscope 10 is configured as a flexible endoscope. The end portion 12 is configured with low flexibility as compared with the insertion portion 14. An optical fiber 34, a wiring cable 36, and the like are inserted into the interior of the insertion portion 14. The coupling portion 16 is configured as a plug or the like that allows the endoscope 10 to be coupled to the light source 38 and the control unit 40.

The light projector unit 20 emits a patterned light such as an interference fringe pattern 90 to a target. The end portion 12 is provided with the cover glass 32. The light projector unit 20 projects a patterned light through the cover glass 32. The light projector unit 20 includes an optical circuit unit 22, a projection lens 24, and a lens holder unit 26.

The optical circuit unit 22 is configured as a so-called planar optical integrated circuit (PLC; Planar Lightwave Circuit). For example, a waveguide structure is formed on a silicon substrate using silica materials. The optical circuit unit 22 is coupled to the optical fiber 34 via a fiber block 28. The optical circuit unit 22 includes multiple waveguides each capable of supporting phase modulation. Multiple light beams output from the multiple waveguides are subjected to interference so as to generate a patterned light. By changing the phase difference between the multiple waveguides by means of the optical circuit unit 22, this arrangement is capable of supporting multiple kinds of patterned lights, i.e., multiple kinds of interference fringe patterns 90 having different bright positions and dark positions.

The projection lens 24 shapes the multiple beams output from the optical circuit unit 22, so as to generate the interference fringe pattern 90 in a desired region. The lens holder unit 26 holds the projection lens 24 such that the projection lens 24 is arranged at a desired position with respect to the optical circuit unit 22. The lens holder unit 26 holds the projection lens 24 so as to provide a so-called “off-axis system” in which the optical axis of the projection lens 24 is arranged with an offset with respect to the optical circuit unit 22. With this arrangement, the projection axis A of the light projector unit 20 and the image acquisition axis B of the image acquisition unit 30 intersect. It should be noted that the angle θ between the projection axis A and the image acquisition axis B is on the order of 1° to 30° depending on the distance between the end portion 12 and the measurement target. With this arrangement, in a case in which the center-to-center distance between the projection lens 24 and the image acquisition lens 52 is 1 mm, this angle range corresponds to a distance on the order of 2 mm to 50 mm, up to an intersection 92 between the projection axis A and the image acquisition axis B, i.e., up to the target.

The image acquisition unit 30 acquires an image of a target onto which the interference fringe pattern 90 has been projected, and generates an interference fringe image based on the patterned light. The image acquisition unit 30 receives, through the cover glass 32, the light reflected from the target onto which the interference fringe pattern 90 has been projected. The image acquisition unit 30 acquires images of the target onto which the interference fringe pattern 90 has been projected with multiple kinds of patterned light beams having different position relations between bright and dark. Furthermore, the image acquisition unit 30 generates multiple kinds of interference fringe images that respectively correspond to the multiple kinds of patterned light beams. The image acquisition unit 30 is fixedly mounted on the optical circuit unit 22, and is electrically coupled to a wiring unit 48 provided to the optical circuit unit 22. The wiring unit 48 is coupled to the wiring cable 36. The interference fringe image acquired by the image acquisition unit 30 is transmitted to the control unit 40 via the wiring cable 36.

The light source 38 outputs a coherent light beam so as to generate the interference fringe pattern 90. For example, the light source 38 outputs a single-wavelength laser light beam. The output light beam of the light source 38 is input to the optical circuit unit 22 via the optical fiber 34. The light source 38 includes a solid-state laser source such as a semiconductor laser element or the like. The output wavelength supported by the light source 38 is not restricted in particular. For example, a red light beam having a wavelength λ=635 nm may be employed. The light source 38 may include a control mechanism configured to control the driving current and the operation temperature of the light-emitting element so as to maintain the output intensity and the output wavelength of the light source 38 at a constant level. The control mechanism may include a photoreceptor element and a driving element configured to support a feedback driving operation according to the output intensity of the light source 38, a Peltier element configured to control the temperature of the light source 38, etc. By providing such a control mechanism, this arrangement is capable of stabilizing the output wavelength of the light source 38, thereby suppressing fluctuation of the bright-and-dark period of the generated interference fringe pattern.

The control unit 40 controls the operation of the light projector unit 20, and acquires an interference fringe image acquired by the image acquisition unit 30. The control unit 40 controls the phase difference between the multiple waveguides provided to the optical circuit unit 22 so as to scan the interference fringe pattern 90. The control unit 40 acquires, from the image acquisition unit 30, multiple kinds of interference fringe images respectively corresponding to the multiple kinds of patterned light beams. Furthermore, the control unit 40 generates a distance image or a three-dimensional display image based on the multiple kinds of interference fringe images. Before the generation of such a distance image or three-dimensional display image, first, a phase distribution image is generated. The phase distribution image is an image of an initial phase value of each pixel position of the interference fringe image. The phase distribution image can be calculated based on a known algorithm using the phase value of each of the multiple kinds of patterned light beams and each pixel value of the multiple interference fringe images. Subsequently, a three-dimensional shape of the target is geometrically derived based on the phase distribution image and the layout of the light projector unit 20 and the image acquisition unit 30, thereby acquiring the distance image or the three-dimensional display image.

FIG. 2 is a top view showing a more detailed view of the end portion 12 shown in FIG. 1, which corresponds to an enlarged partial view of FIG. 1. In FIG. 2, the direction in which the image acquisition axis B extends (which will also be referred to as the “image acquisition axis direction”) is defined as the z direction. Furthermore, the direction in which the distance between the projection axis A and the image acquisition axis B becomes larger is defined as the x direction. Moreover, the direction that is orthogonal to both the x direction and the z direction is defined as the y direction.

The optical circuit unit 22 includes a substrate 60, and an input waveguide 41, a splitter unit 42, a first waveguide 43, a second waveguide 44, a first phase modulator 45, a second phase modulator 46, and a wiring unit 48, which are provided on the substrate 60. The input waveguide 41, the splitter unit 42, the first waveguide 43, and the second waveguide 44 are configured as a waveguide structure formed on the substrate 60. The input waveguide 41 is coupled to the optical fiber 34 via the fiber block 28. The light beam input to the input waveguide 41 is split by the splitter unit 42 into the first waveguide 43 and the second waveguide 44. The first waveguide 43 is configured such that it extends linearly from the splitter unit 42 toward a first outlet 43a. The second waveguide 44 is configured such that it extends linearly from the splitter unit 42 toward a second outlet 44a.

In the example shown in the drawings, the first waveguide 43 and the second waveguide 44 are arranged such that they extend linearly in the z direction with an offset between them in the x direction. That is to say, the first waveguide 43 and the second waveguide 44 are arranged such that they extend in the z direction in parallel with each other. Furthermore, the input waveguide 41, the splitter 42, and the pair of the first waveguide 43 and the second waveguide 44 are sequentially arranged in the z direction. The input waveguide 41 is configured to have a z-direction length on the order of 0.5 mm. The splitter unit 42 is configured to have a z-direction length on the order of 1 mm. The first waveguide 43 and the second waveguide 44 are each configured to have a z-direction length on the order of 2.5 mm. The substrate 60 is configured to have a z-direction length on the order of 4 mm. The distance between the first outlet 43a and the second outlet 44a is on the order of 50 μm to 100 μm.

It should be noted that the structures of the input waveguide 41, the splitter unit 42, the first waveguide 43, and the second waveguide 44 are not restricted to those shown in the drawings. Also, such components may be configured to have other structures. Also, in addition to the Y-branch waveguide shown in the drawings, the splitter unit 42 may be configured as a directional coupler, a multimode interference coupler, or a star coupler. The overall structure of the input waveguide 41, the first waveguide 43, and the second waveguide 44 is not restricted to such a linear structure. Also, such an overall structure of the input waveguide 41, the first waveguide 43, and the second waveguide 44 may include a curved portion.

The first phase modulator 45 is provided along the first waveguide 43, and changes the optical length of the first waveguide 43 so as to control the phase of the light beam that propagates through the first waveguide 43. The second phase modulator 46 is provided along the second waveguide 44, and changes the optical length of the second waveguide 44 so as to control the phase of the light beam that propagates through the second waveguide 44. The first phase modulator 45 and the second phase modulator 46 respectively control the phases provided by the waveguides 43 and 44 using the electro-optic effect or the thermo-optic effect. The first phase modulator 45 and the second waveguide 44 are each configured as a heater, which respectively heat the waveguides 43 and 44 so as to change the phases to be provided by the corresponding waveguides 43 and 44. The first phase modulator 45 and the second phase modulator 46 are electrically coupled to the wiring unit 48, and operate according to a control signal received from the control unit 40.

The light beam phase modulated by the first waveguide 43 is emitted from the first outlet 43a. The light beam phase modulated by the second waveguide 44 is emitted from the second outlet 44a. The first outlet 43a and the second outlet 44a are provided on a side face 22c of the optical circuit unit 22. The side face 22c is defined as a plane (xy plane) that is orthogonal to the z direction, which intersects both the direction in which the projection axis A extends (which will also be referred to as the “projection axis direction”) and the image acquisition axis direction.

The projection lens 24 is fitted and fixed to a holder groove 27 of the lens holder unit 26. The holder groove 27 is a groove incised in a cross shape such that it extends in the x direction and the z direction. The holder groove 27 assists in the alignment of the projection lens 24 in the three directions comprising the x, y, and z directions. The holder groove 27 is designed to have a structure such that the projection lens 24 is arranged at a predetermined position with respect to the first outlet 43a and the second outlet 44a. For example, the holder groove 27 is designed to have a structure such that the projection lens 24 is arranged at a position with an offset in the x direction with respect to a virtual wave source 47 defined as an intermediate point between the first outlet 43a and the second outlet 44a. Here, the virtual wave source 47 represents a virtual light source for a patterned light such as the interference fringe pattern 90 or the like, which can be regarded optically as a point from which a patterned light is emitted.

The lens holder unit 26 is mounted on the side face 22c of the optical circuit unit 22 such that it is arranged adjacent to the optical circuit unit 22 in the z direction. Accordingly, the lens holder unit 26 is fixed to the optical circuit unit 22, and is fixedly mounted on a mounting face that intersects both the projection axis direction and the image acquisition axis direction. The lens holder unit 26 is preferably configured of a material having a low thermal expansion rate, and is configured of a glass material such as silica glass or the like. The lens holder unit 26 is mounted on the side face 22c of the optical circuit unit 22 by means of adhesion using an adhesive agent, fusion bonding, or the like.

The image acquisition unit 30 includes an image acquisition element 50 and an image acquisition lens 52. The image acquisition lens 52 forms, on the image acquisition element 50, an image of the target onto which the interference fringe pattern 90 has been projected. The image acquisition element 50 is configured as an image sensor such as a CCD, CMOS sensor, or the like, which outputs an image signal based on the interference fringe image thus acquired. The image acquisition element 50 is electrically coupled to the wiring unit 48 of the optical circuit unit 22. The image acquisition element 50 transmits an image signal based on the interference fringe image to the control unit 40 via the wiring cable 36.

The image acquisition unit 30 is mounted on the side face 22c of the optical circuit unit 22, and is arranged adjacent to the optical circuit unit 22 in the z direction. The image acquisition unit 30 is fixed to the optical circuit unit 22, and is fixedly mounted on a mounting face that intersects both the projection axis direction and the image acquisition axis direction. In the present example, the image acquisition unit 30 is fixedly mounted on the mounting face that is orthogonal to the image acquisition axis direction. The image acquisition unit 30 is mounted on the side face 22c of the optical circuit unit 22 by means of adhesion using an adhesive agent, fusion bonding, or the like. The coupling portion of the image acquisition unit 30 to be coupled to the side face 22c of the optical circuit unit 22 may be configured of a glass material such as silica glass.

The image acquisition unit 30, the projection lens 24, and the lens holder unit 26 are arranged side-by-side in the x direction. It should be noted that no fixing member is provided between the lens holder unit 26 and the image acquisition unit 30. The relative positions of the lens holder unit 26 and the image acquisition unit 30 are defined with the side face 22c of the optical circuit unit 22 as a reference.

The fiber block 28 and the optical fiber 34 are mounted on another side face 22d of the optical circuit unit 22 that is opposite to the side face 22c on which the lens holder unit 26 and the image acquisition unit 30 are mounted. The fiber block 28 and the optical fiber 34 are mounted on the side face 22d of the circuit unit 22 by adhesion using an adhesive agent, fusion bonding, or the like.

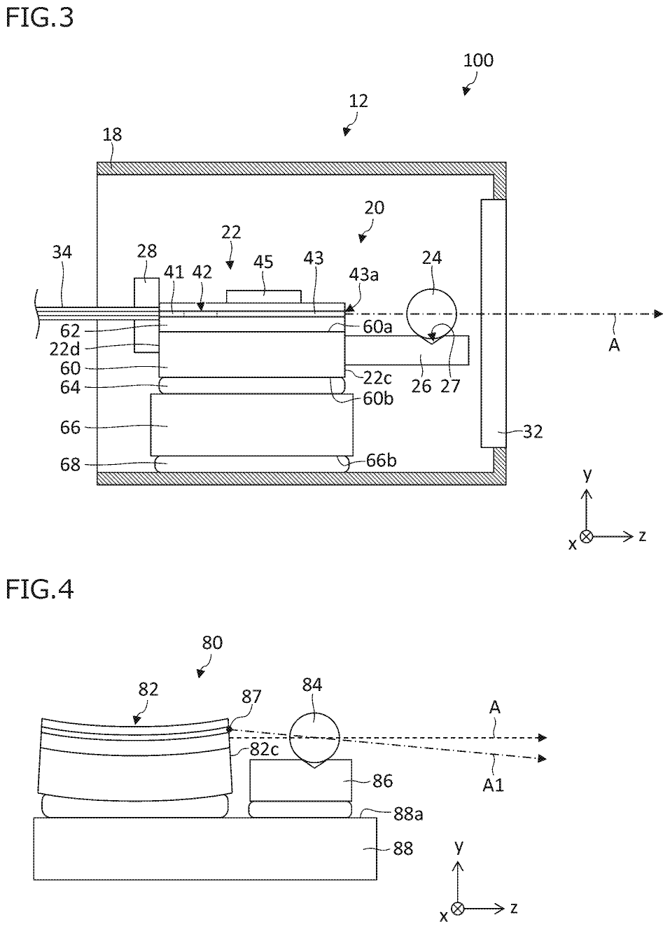

FIG. 3 is a side view showing a schematic configuration of the light projector unit 20 as viewed along the x direction. The optical circuit unit 22 includes the substrate 60 and a cladding layer 62 provided on an upper face 60a of the substrate 60. The substrate 60 is configured as a silicon wafer, for example. The cladding layer 62 is configured of a material including silicon oxide (SiO₂) as a main component. A waveguide structure of the optical circuit unit 22 is provided in the cladding layer 62. For example, the input waveguide 41, the splitter unit 42, the first waveguide 43, and the second waveguide 44 are configured as a core portion provided within the cladding layer 62. The first phase modulator 45 and the second phase modulator 46 are provided on the cladding layer 62. Furthermore, the wiring portion 48 (not shown in FIG. 3) is provided on the cladding layer 62.

The substrate 60 is fixedly mounted on a carrier base 66 via a first adhesive layer 64. The carrier base 66 is arranged on a lower face 60b side of the substrate 60 that is opposite to the upper face 60a. The carrier base 66 is fixed to a housing 18 via a second adhesive layer 68. Accordingly, the optical circuit unit 22 is fixedly mounted on the housing 18 via the carrier base 66. In the example shown in the drawing, the second adhesive layer 68 is provided to the lower face 66b that is opposite to the substrate 60 across the carrier base 66. Accordingly, the carrier base 66 is fixedly mounted on the housing 18 via the lower face 66b of the carrier base 66. It should be noted that the fixing method for the carrier base 66 is not restricted in particular. Also, the carrier base 66 may be fixedly mounted on the housing 18 via its side face. Also, instead of employing the carrier base 66, the substrate 60 may be fixedly mounted on the housing 18 via the first adhesive layer 64.

The material of the carrier base 66 is not restricted in particular. At least one from among metal materials, resin materials, and ceramic materials may be employed. As the carrier base 66, a glass epoxy substrate or an aluminum (Al) substrate may be employed. Also, the materials of the first adhesive layer 64 and the second adhesive layer 68 are not restricted in particular. At least one from among resin materials and metal materials may be employed. As the first adhesive layer 64 and the second adhesive layer 68, adhesive tape, a resin adhesive agent, silver (Ag) paste, solder, or the like may be employed, for example.

The lens holder unit 26 is fixedly mounted on the side face 22c of the optical circuit unit 22. The lens holder unit 26 is fixedly mounted on a side face of the substrate 60, for example. The lens holder unit 26 may be fixed on only a side face of the substrate 60, or may be fixed to side faces of both the substrate 60 and the cladding layer 62. However, the lens holder unit 26 is directly fixed to neither the carrier base 66 nor the housing 18. In a case in which deformation or displacement occurs due to the occurrence of warpage or the like in the substrate 60 or the cladding layer 62, the lens holder unit 26 is displaced according to the deformation or displacement. It should be noted that the same can be said of the image acquisition unit 30, which is not shown in FIG. 3.

Next, description will be made regarding the operation of the optical measurement apparatus 100. The optical circuit unit 22 splits the light beam received from the light source 38 into the first waveguide 43 and the second waveguide 44. The control unit 40 drives the first phase modulator 45 and the second phase modulator 46 so as to control the phase difference between the first waveguide 43 and the second waveguide 44. The projection lens 24 generates interference between two phase-modulated light beams emitted from the first outlet 43a and the second outlet 44a, and projects a patterned light onto the target. The image acquisition unit 30 acquires an interference fringe image of the target onto which the patterned light has been projected. The control unit 40 changes the phase difference between the first waveguide 43 and the second waveguide 44 so as to change the bright and dark positions of the interference fringe pattern 90. The image acquisition unit 30 generates multiple kinds of interference fringe images corresponding to the multiple kinds of interference fringe patterns 90 having different bright and dark position relations. The control unit 40 analyzes the multiple kinds of interference fringe images thus acquired, so as to derive a three-dimensional shape of the target.

In the operation of the optical measurement apparatus 100, the internal portion of the housing 18 is heated mainly due to heat involved in the operation of the optical circuit unit 22 and the image acquisition unit 30. Furthermore, heat generation occurs in the optical circuit unit 22 mainly due to the driving of the first phase modulator 45 and the second phase modulator 46. Furthermore, heat generation occurs in the image acquisition unit 30 due to the driving of semiconductor elements such as transistors or the like included in the image acquisition element 50. The components provided within the housing 18 are fixed to each other. Such an arrangement has the potential to cause the occurrence of deformation such as warpage or the like due to the difference in the thermal expansion rate between the components. In particular, the optical circuit unit 22 is configured to have a long length in the z direction in which the waveguides extend, and to have a small thickness in the y direction. Accordingly, warpage readily occurs due to the difference in the thermal expansion rate between the substrate 60 and the cladding layer 62. In a case in which the position relation between the projection axis A and the image acquisition axis B changes due to deformation or displacement of each component, this leads to degradation of measurement precision supported by the fringe scanning method. This is because, in the fringe scanning method, the depth or height of the target surface is derived based on the angle θ between the projection axis A and the image acquisition axis B.

FIG. 4 is a schematic diagram showing the change in the projection axis A in a case in which warpage occurs in the optical circuit unit 82 according to a comparison example. In the comparison example shown in the drawing, the optical circuit unit 82 and the lens holder unit 86 are mounted on an upper face 88a of a carrier base 88. That is to say, the upper face 88a, which is defined as a plane extending in a direction along the projection axis A, is used as the mounting face. This is the point of difference from the above-described example. In the present comparison example, an unshown image acquisition unit is mounted on the upper face 88a of the carrier base 88. In the optical circuit unit 82, the cladding layer has a thermal expansion rate that is smaller than the substrate. Accordingly, when the optical circuit unit 82 is heated due to the driving operation, the substrate expands with a relatively large thermal expansion rate, leading to the occurrence of warpage such that it protrudes downward. As a result, the side face 82c of the optical circuit unit 82 on which a virtual wave source 87 is defined is inclined such that the side face 82c is displaced upward. On the other hand, the lens holder unit 86 is arranged away from the optical circuit unit 82. Accordingly, the amount of thermal deformation in the lens holder unit 86 is smaller as compared with the optical circuit unit 82. As a result, the direction of the projection axis A1 that connects between the virtual wave source 87 and the center of the projection lens 84 deviates from the projection axis A as defined before the thermal deformation. With the position of the side face 82c of the optical circuit unit 82 as a reference, after the thermal deformation, the side face 82c is displaced upward, and the projection axis A1 is displaced downward. Accordingly, there is a large deviation of the projection axis between A and A1 as viewed from the side face 82c between before and after the thermal deformation.

In this state, in a case in which the projection axis B of the image acquisition unit 30 changes in the same way as the projection axis A1, this arrangement has the potential to maintain the position relation between the projection axis A1 and the image acquisition axis B even after the thermal deformation. However, in a case in which the image acquisition unit is mounted on the carrier base 88 independent of the optical circuit unit 82, it is conceivable that, in many cases, the deformation state of the optical circuit unit 82 does not match the deformation state of the image acquisition unit. As a result, the position relation between the projection axis A1 and the image acquisition axis B deviates due to thermal deformation, which has an effect on the measurement precision supported by the fringe scanning method. As a result of estimation calculated by the present inventor, the occurrence of deviation of only 1 μm in the position of the virtual wave source 87 leads to the occurrence of measurement error of approximately 1 mm in the three-dimensional shape measurement of the target. If the deformation of the optical circuit unit 82 becomes even larger, this arrangement has the potential to lead to a further increase in measurement error.

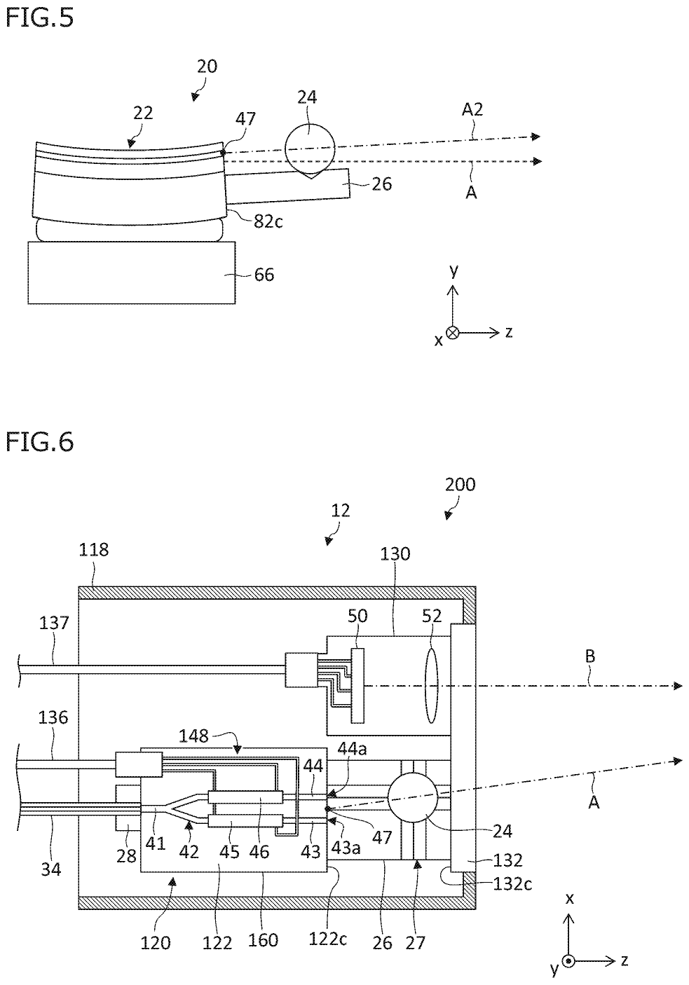

FIG. 5 is a schematic diagram showing the change in the projection axis A in a case in which warpage has occurred in the optical circuit unit 22 according to the example. In the example shown in the drawing, as with the above-described comparison example, the side face 22c inclines due to the occurrence of warpage in the optical circuit unit 22, which displaces the optical circuit unit 22 upward (y direction). In the present example, the lens holder unit 26 is also displaced in the y direction according to the deformation of the side face 22c. Accordingly, the change in the relative position of the projection lens 24 is small with the position of the side face 22c of the optical circuit unit 22 as a reference. As a result, the relative change in the direction of the projection axis A2 from the projection axis A defined before the thermal deformation is small with the position of the side face 22c of the optical circuit unit 22 as a reference.

Similarly, in the present example, the image acquisition unit 30 is also displaced according to the warpage of the optical circuit unit 22. Accordingly, the change in the relative position of the image acquisition unit 30 is also small with the position of the side face 22c of the optical circuit unit 22 as a reference. As a result, this arrangement is capable of maintaining the direction relation between the projection axis A and the image acquisition axis B as viewed from the side face 22c of the optical circuit unit 22. This suppresses the change in the position relation between the projection axis A and the image acquisition axis B, thereby allowing the change in the angle θ defined between the projection axis A and the image acquisition axis B to be reduced. This allows degradation of the measurement precision due to thermal deformation to be suppressed.

### Second Example

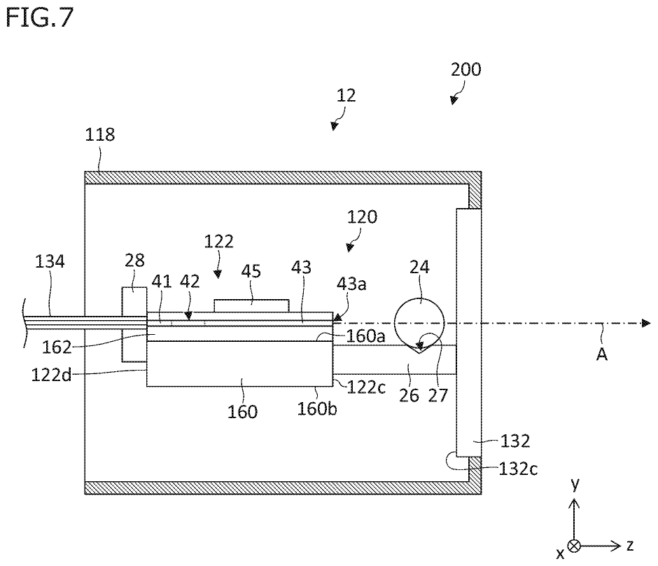

FIGS. 6 and 7 are diagrams each showing a schematic configuration of an optical measurement apparatus 200 according to a second example. FIG. 6 is a top view, which corresponds to FIG. 2 described above. FIG. 7 is a side view, which corresponds to FIG. 3 described above. In the present example, a light projector unit 120 and an image acquisition unit 130 are mounted on a main face 132c of a cover glass 132. That is to say, the main face 132c of the cover glass 132 is to be used as a mounting face that functions as the reference of the mounting position. This is the point of difference from the above-described first example. Description will be made regarding the present example directing attention to the points of difference from the above-described example.

The optical measurement apparatus 200 includes the light projector unit 120 and the image acquisition unit 130. The light projector unit 120 and the image acquisition unit 130 are provided within an internal portion of a housing 118 of the end portion 12 of the endoscope. The cover glass 132 is mounted on the housing 118 such that it intersects both the projection axis A and the image acquisition axis B. The light projector unit 120 and the image acquisition unit 130 are fixedly mounted on the main face 132c of the cover glass 132. The main face 132c of the cover glass 132 is configured as a mounting face defined such that it intersects both the projection axis A and the image acquisition axis B. It can be said that the cover glass 132 functions as a fixing member to be used for alignment of the light projector unit 120 and the image acquisition unit 130.

The light projector unit 120 includes an optical circuit unit 122, a projection lens 24, and a lens holder unit 26. The optical circuit unit 122 includes a substrate 160 and a cladding layer 162 provided on an upper face 160a of the substrate 160. The cladding layer 162 is provided with a waveguide structure formed in the same manner as in the first example described above. A first phase modulator 45, a second phase modulator 46, and a wiring unit 148 are provided on the cladding layer 162. The wiring unit 148 is electrically coupled to the first phase modulator 45 and the second phase modulator 46, and is coupled to a control unit 40 via a first wiring cable 136.

The lens holder unit 26 is mounted on the main face 132c of the cover glass 132. The lens holder unit 26 is mounted on the main face 132c by adhesion using an adhesive agent, fusion bonding, or the like. The lens holder unit 26 is mounted on a side face 122c of the optical circuit unit 122 in the same manner as in the first example described above. On the other hand, the optical circuit unit 122 is fixedly mounted on only the lens holder unit 26. That is to say, in the present example, the carrier base 66 is not provided, unlike the first example. That is to say, there is no member to be used for fixed coupling between a lower face 160b of the substrate 160 and the housing 118. As a result, the optical circuit unit 122 is fixedly mounted on the cover glass 132 via the lens holder unit 26.

The image acquisition unit 130 includes an image acquisition element 50 and an image acquisition lens 52 in the same manner as in the first example. The image acquisition unit 50 is electrically coupled to a second wiring cable 137. An image signal is transmitted to the control unit 40 via the second wiring cable 137. The image acquisition unit 130 is fixedly mounted on the main face 132c of the cover glass 132 such that the image acquisition axis B thereof is orthogonal to the main face 132c of the cover glass 132.

With the present example, by fixedly mounting the optical projector unit 120 and the image acquisition unit 130 on the mounting face defined such that it intersects both the projection axis direction and the image acquisition axis direction, this arrangement is also capable of suppressing change in the relative position relation between the projection axis A and the image acquisition axis B due to thermal deformation. In the present example, the lens holder unit 26 and the image acquisition unit 130 are fixedly mounted on a fixing member (cover glass 132) formed of a glass material having a small thermal expansion rate. This arrangement is capable of suppressing change in the relative positions of the projection lens 24 and the image acquisition lens 52. Furthermore, the lens holder unit 26 is fixedly mounted on the side face 122c of the optical circuit unit 122. Accordingly, this arrangement is capable of fixedly maintaining the position relation between the side face 122c and the lens holder unit 26 even if warpage occurs in the optical circuit unit 122. As a result, this arrangement is capable of suppressing change in the relative positions of the projection lens 24 and the virtual wave source 47 defined on the side face 122c of the optical circuit unit 122. Accordingly, with the present example, this arrangement involves only a small change in the relative positions of the projection axis A and the image acquisition axis B that occurs due to thermal deformation. This suppresses degradation of measurement precision that occurs due to thermal deformation.

### Third Example

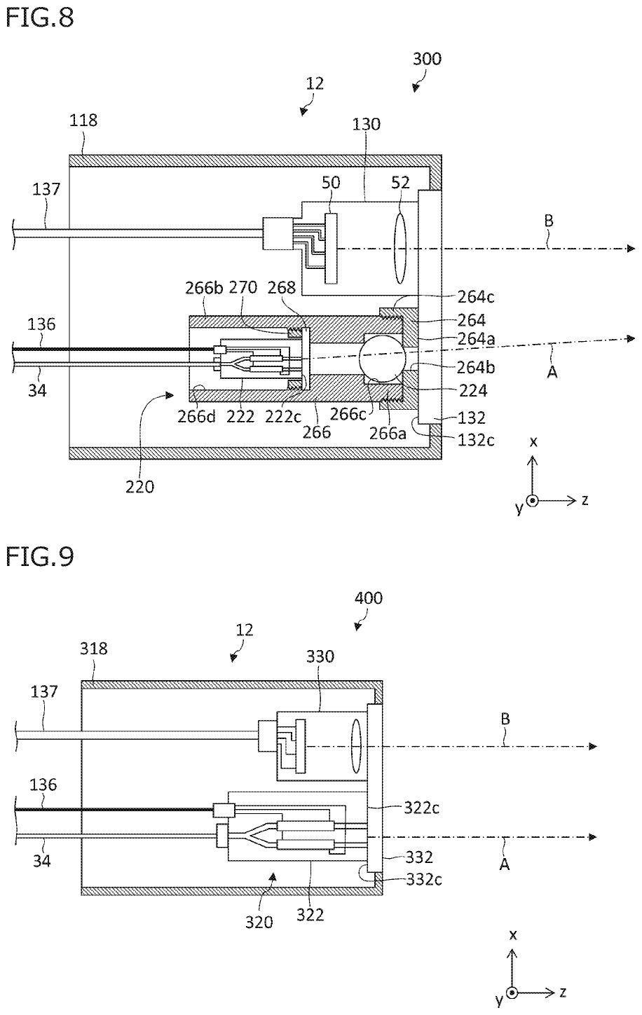

FIG. 8 is a diagram showing a schematic configuration of an optical measurement apparatus 300 according to a third example. In the present example, a light projector unit 220 and an image acquisition unit 130 are mounted on a main face 132c of a cover glass 132, which is a point in common with the second example described above. However, an optical circuit unit 222 included in the light projector unit 220 and a projection lens 224 are fixedly mounted using a method that differs from that employed in the above-described example. Description will be made regarding the present example directing attention to the points of difference from the above-described example.

The optical measurement apparatus 300 includes the light projector unit 220 and the image acquisition unit 130. The light projector unit 220 and the image acquisition unit 130 are provided in an internal portion of a housing 118 of an end portion 12 of an endoscope. The light projector unit 220 and the image acquisition unit 130 are fixedly mounted on the main face 132c of the cover glass 132.

The light projector unit 220 includes the optical circuit unit 222, the projection lens 224, a first holder member 264, a second holder member 266, a third holder member 268, and a fourth holder member 270. The optical circuit unit 222 is fixedly mounted on the third holder member 268. Furthermore, the optical circuit unit 222 is fixedly mounted in the internal portion of the second holder member 266 via the third holder member 268. The optical circuit unit 222 is coupled to the third holder member 268 via its side face 222c provided with outlets of waveguides. The projection lens 224 is fixedly mounted such that it is interposed between the first holder member 264 and the second holder member 266.

The first holder member 264 includes a bottom face 234a to be fixedly mounted on the main face 132c of the cover glass 132. An opening 234b is formed in a central portion of the bottom face 234a so as to allow a patterned light to pass through. An engagement unit 234c is provided on a side that is opposite to the bottom face 234a, in order to fixedly mount the second holder member 266. The engagement portion 234c is provided such that it protrudes in the z direction. A threading structure is provided to the inner face of the engagement portion 234c so as to allow the engagement portion 234c to be screwed onto a first end portion 266a of the second holder member 266.

The second holder member 266 is a cylindrical member configured to house the optical circuit unit 222 within its internal portion. The first end portion 266a of the second holder member 266 is provided with a first recess portion 266c configured to receive the projection lens 224. A second end portion 266b that is opposite to the first end portion 266a is provided with a second recess portion 266d configured to house the optical circuit unit 222. The first recess portion 266c and the second recess portion 266d are configured such that they communicate with each other via an internal space extending in the axial direction (z direction).

The third holder member 268 is configured as a flat plate member having light transmissivity. The optical circuit unit 222 is mounted on the third holder member 268 such that the side face 222c of the optical circuit unit 222 is coupled to the third holder member 268. The third holder member 268 is fitted to the bottom of the second recess portion 266d, and is arranged such that it is interposed between the second holder member 266 and the fourth holder member 270. The fourth holder member 270 is configured as a ring-shaped member. By screwing the fourth holder member 270 into a threading structure formed in the bottom of the second recess portion 266d, the third holder member 268 is fixedly arranged.

With the present example, the optical circuit unit 222 and the projection lens 224 are fixedly mounted by means of the second holder member 266 having a cylindrical structure. This arrangement involves only a small change in the relative positions of the optical circuit unit 222 and the projection lens 224 that occurs due to thermal deformation. Furthermore, the optical circuit unit 222 is fixedly mounted on the second holder member 266 with the side face 222c of the optical circuit unit 222 that emits a patterned light as a reference. Accordingly, this arrangement is capable of suppressing displacement of the side face 222c so as to suppress a change in the position relation between the side face 222c and the projection lens 224 even if warpage occurs in the optical circuit unit 222 due to thermal deformation. Furthermore, with the present example, the light projector unit 220 is fixedly mounted on a mounting face (main face 132c of the cover glass 132) defined such that it intersects both the projection axis direction and the image acquisition axis direction. Accordingly, this arrangement is capable of suppressing change in the relative position relation between the projection axis A and the image acquisition axis B, thereby suppressing degradation of measurement precision due to thermal deformation.

### Modification 1

FIG. 9 is a top view showing a schematic configuration of an optical measurement apparatus 400 according to a modification 1. In the present modification, no projection lens is provided to a light projector unit 320. Instead, the present modification is configured such that the patterned lights emitted from multiple waveguides of an optical circuit unit 322 are projected onto a target without involving a lens. The optical circuit unit 322 is arranged such that its side face 322c provided with outlets of the multiple waveguides is fixedly mounted on a main face 332c of the cover glass 322 fixedly mounted on a housing 318. The optical circuit unit 322 is fixedly mounted on a mounting face that is orthogonal to the projection axis A. An image acquisition unit 330 is mounted on a main face 332c of the cover glass 332 in the same manner as in the above-described example. That is to say, the image acquisition unit 330 is fixedly mounted on the mounting face that is orthogonal to the image acquisition axis B. The present modification is capable of achieving the same effects as in the above-described example.

### Modification 2

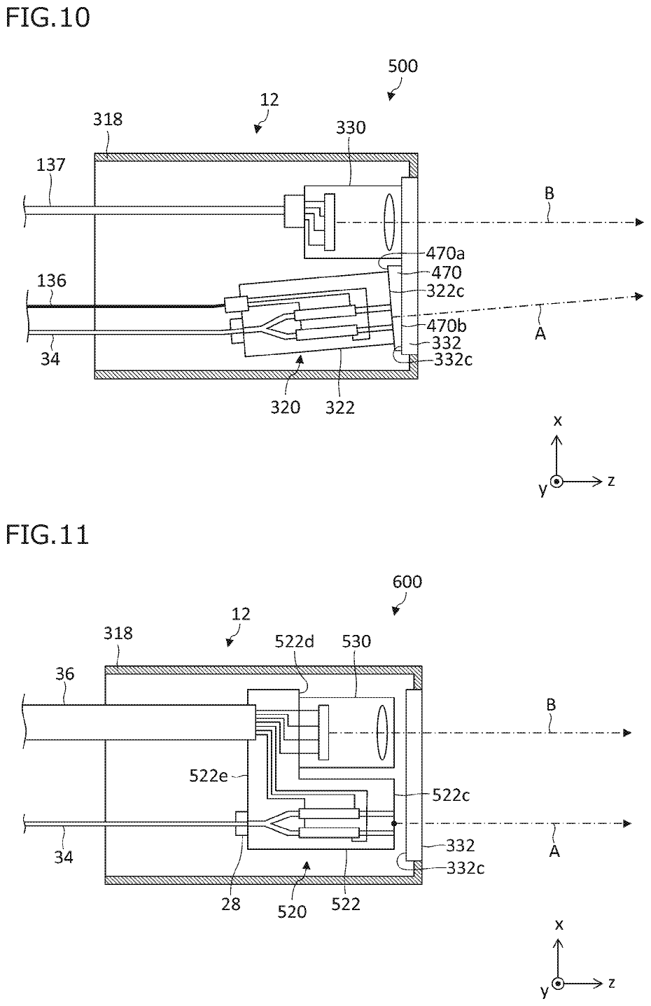

FIG. 10 is a top view showing a schematic configuration of an optical measurement apparatus 500 according to a modification 2. In the present modification, the light projector unit 320 is mounted with a slope with respect to the cover glass 332 such that the projection axis A and the image acquisition axis B intersect. The light projector unit 320 is fixedly mounted on the main face 332c of the cover glass 332 via an intermediate member 470. The intermediate member 470 has a first face 470a to be fixedly mounted on the main face 322c of the optical circuit unit 322 and a second face 470b to be fixedly mounted on the main face 332c of the cover glass 332. The intermediate member 470 is configured such that its first face 470a has a slope with respect to its second face 470b with a slope angle corresponding to the intersection angle at which the projection axis A intersects the image acquisition axis B. The present modification achieves the same effects as those provided by the above-described example.

### Modification 3

FIG. 11 is a top view showing a schematic configuration of an optical measurement apparatus 600 according to a modification 3. The present modification is configured such that an optical circuit unit 522 functions as a mounting position reference in the same manner as in the first example described above. That is to say, an optical projector unit 520 and an image acquisition unit 530 are not fixedly mounted on the cover glass 332. Furthermore, no mounting member or intermediate member is provided between the optical projector unit 520 and the image acquisition unit 530 and the cover glass 332. The optical circuit unit 522 has a first side face 522c on which outlets of multiple waveguides are provided, a second side face 522d on which the image acquisition unit 530 is to be mounted, and a third side face 522e to which the optical fiber 34 and the wiring cable 36 are to be coupled. The first side face 522c and the second side face 522d are provided on a side that is opposite to the third side face 522e with an offset between them in the z direction. The first side face 522c and the second side face 522d are arranged in parallel with each other such that they intersect or are orthogonal to the projection axis direction and the image acquisition axis direction. With the present modification, the image acquisition unit 530 is fixedly mounted with the side faces of the optical circuit unit 522 that intersect both the projection axis direction and the image acquisition axis direction as a reference, thereby achieving the same effects as those provided in the above-described example.

### Modification 4

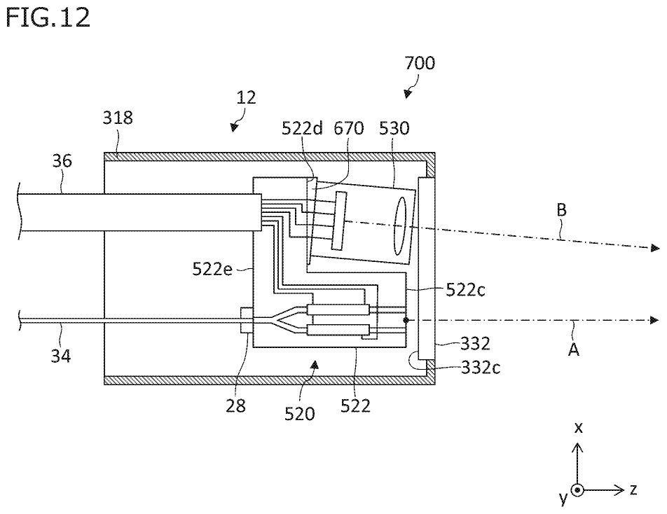

FIG. 12 is a top view showing a schematic configuration of an optical measurement apparatus 700 according to a modification 4. In the present modification, the image acquisition unit 530 is mounted with a slope with respect to the optical circuit unit 522 such that the projection axis A intersects the image acquisition axis B. The image acquisition unit 530 is fixedly mounted on the second side face 522d of the optical circuit unit 522 via an intermediate member 670. The intermediate member 670 is configured to have a first face to be fixedly mounted on the second side face 522d of the optical circuit unit 522 and a second face to be fixed to the image acquisition unit 530. The second face is configured with a slope with respect to the first face. With the present modification, the image acquisition unit 530 is fixedly mounted with the side face of the optical circuit unit 522 that intersects both the projection axis direction and the image acquisition axis direction as a reference, thereby providing the same effects as those achieved by the above-described example.

In yet another modification, instead of providing the intermediate member 670, the optical circuit unit 522 may be configured such that its second side face 522d has a slope with respect to its first side face 522c. The image acquisition unit 530 may be fixedly mounted on the second side face 522d thus configured with such a slope.

Description has been made above regarding the present invention with reference to the examples. The above-described examples have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

Description has been made in the above-described example regarding an arrangement in which the optical measurement apparatus is configured as a flexible endoscope. In yet another modification, the optical measurement apparatus may be configured as a rigid endoscope including an insertion portion having no flexibility. Also, such an endoscope may be configured for medical use or industrial use. Also, the optical measurement apparatus according to the present example is not necessarily built into such an endoscope. Also, in addition to the fringe scanning method, the above-described examples and modifications may be applied to other measurement techniques using a structured illumination method.

Description has been made in the above-described example regarding the optical circuit unit having a Y-branch waveguide structure in which a phase modulator is provided to each of the first waveguide and the second waveguide thereof. In yet another modification, only a single phase modulator may be provided to any one from among the first waveguide and the second waveguide.

Description has been made in the above-described example regarding an arrangement in which a ball lens is employed as the projection lens. In yet another example, a plano-convex lens may be employed as the projection lens. Also, a concave lens may be employed as the projection lens. Also, the projection lens may be configured as a combination of multiple lenses including a concave lens or a convex lens.

Description has been made in the above-described first example regarding an arrangement in which the lens holder unit 26 and the image acquisition unit 30 are mounted on the same side face 22c of the optical circuit unit 22. In yet another modification, as shown in FIG. 11, the optical circuit unit may be provided with the first side face and the second side face arranged with an offset between them in the z direction. In this arrangement, the lens holder unit may be mounted on the first side face, and the image acquisition unit may be mounted on the second side face. That is to say, the lens holder unit and the image acquisition unit may be mounted on different respective side faces of the optical circuit unit.

What is claimed is:

1. An optical measurement apparatus comprising:
a light projector that emits a patterned light; and
an imager that acquires an image of a target onto which the patterned light has been projected,
wherein the light projector comprises an optical circuit, the optical circuit including:
a substrate; and
a plurality of waveguides provided on the substrate, each of the plurality of waveguides being capable of supporting phase modulation,
wherein the optical circuit comprises a side face provided with outlets of the plurality of waveguides, and
wherein the imager is fixedly mounted on the side face of the optical circuit.

2. The optical measurement apparatus according to claim 1, further comprising a housing in which the light projector and the imager are housed,
wherein the light projector is fixed to the housing,
and wherein the imager is fixed to the housing via the light projector.

3. The optical measurement apparatus according to claim 1, wherein the light projector further comprises:
a projection lens that projects the patterned light onto the target by interfering a plurality of light beams emitted from the plurality of waveguides; and
a lens holder that holds the projection lens,
and wherein the lens holder is fixed to the optical circuit.

4. The optical measurement apparatus according to claim 3, the lens holder are fixedly mounted on the side face of the optical circuit.

5. An optical measurement apparatus comprising:
a light projector that emits a patterned light;
an imager that acquires an image of a target onto which the patterned light has been projected; and
a fixing member having a mounting face and having light transmissivity, wherein both the light projector and the imager are mounted on the mounting face,
wherein the light projector projects the patterned light onto the target through the fixing member,
and wherein the imager acquires an image of the target through the fixing member.

6. The optical measurement apparatus according to claim 5, further comprising a housing in which the light projector and the imager are housed,
wherein the fixing member is fixed to the housing,
and wherein the light projector and the imager are fixed to the housing via the fixing member.

7. The optical measurement apparatus according to claim 5, wherein the light projector comprises an optical circuit, the optical circuit including:
a substrate; and
a plurality of waveguides provided on the substrate, each of the plurality of waveguides being capable of supporting phase modulation,
and wherein the optical circuit is fixedly mounted on the mounting face of the fixing member.

8. The optical measurement apparatus according to claim 5, wherein the light projector comprises:
an optical circuit including a substrate and a plurality of waveguides providing on the substrate, each of the plurality of waveguides being capable of supporting phase modulation;
a projection lens that projects the patterned light onto the target by interfering a plurality of light beams emitted from the plurality of waveguides; and
a lens holder that holds the projection lens,
and wherein the optical circuit is fixedly mounted on the mounting face of the fixing member via the lens holder.

9. The optical measurement apparatus according to claim 8, wherein the optical circuit have a side face that intersects a projection axis direction of the light projector, and wherein the lens holder is fixedly mounted on the side face.

10. The optical measurement apparatus according to claim 9, wherein outlets of the plurality of waveguides are provided in the side face of the optical circuit.
